(19) United States
(12) Patent Application Publication
(10) Pub. No.: US 2012/0242111 A1
(43) Pub. Date: Sep. 27, 2012

(54) SPRING STRUT RECEPTACLE, VEHICLE FRONT STRUCTURE HAVING THIS SPRING STRUT RECEPTACLE, AND A VEHICLE HAVING THIS VEHICLE FRONT STRUCTURE

(75) Inventors: Udo Mildner, Limburg (DE); Thomas Enderich, Huenstetten (DE)

(73) Assignee: GM GLOBAL TECHNOLOGY OPERATIONS LLC, Detroit, MI (US)

(21) Appl. No.: 13/383,214

(22) PCT Filed: Jul. 5, 2010
(86) PCT No.: PCT/EP10/04060

§ 371 Date: May 29, 2012

(30) Foreign Application Priority Data
Jul. 10, 2009 (DE) 10 2009 032 602.2

(51) Int. Cl. B62D 25/08

(52) U.S. Cl. 296/193.01

(57) ABSTRACT

A spring strut receptacle is provided that is implemented in two parts, and a vehicle front structure having this spring strut receptacle and a motor vehicle which has this vehicle front structure.

### CROSS-REFERENCE TO RELATED APPLICATIONS

This application is a U.S. National-Stage entry under 35 U.S.C. §371 based on International Application No. PCT/EP2010/004060, filed Jul. 5, 2010, which was published under PCT Article 21(2) and which claims priority to German Application No. 10 2009 032 602.2, filed Jul. 10, 2009, which are all hereby incorporated in their entirety by reference.

### TECHNICAL FIELD

The technical field relates to a spring strut receptacle for receiving a spring strut of a motor vehicle. In addition, the technical field relates to a motor vehicle front structure having the above spring strut receptacle, in particular an attachment, which forms a profile, of the spring strut receptacle to the lateral structure of the wheel installation struts, and the technical field also relates to a motor vehicle that has this vehicle front structure.

### BACKGROUND

Typical spring strut receptacles of a vehicle are used to receive a spring strut of a suspension and therefore to introduce and relay the forces acting on the vehicle body or the suspension. Therefore, they represent the connection between the spring strut and the vehicle body.

A vehicle front structure having two laterally situated longitudinal girders, to each of which a wheel housing having a spring strut receptacle for the spring strut of a wheel suspension is connected, is known from document EP 1 081 024 A2. The respective spring strut receptacle is welded to a side part of a bulkhead wall, so that a water box is closed on the bottom and is connected to the upper end of a rear wheel housing strut of a wheel housing.

Therefore, at least one object is to design the vehicle front structure of a motor vehicle, in particular the spring strut receptacle, as stiff in such a manner as to ensure a high level of protection for pedestrians and occupants. In addition, other objects, desirable features, and characteristics will become apparent from the subsequent summary and detailed description, and the appended claims, taken in conjunction with the accompanying drawings and this background.

### SUMMARY

A spring strut receptacle is provided for a motor vehicle is implemented in two parts. Through this two-part structure of the spring strut receptacle, an additional load path is provided for the forces introduced through the spring strut into the vehicle body structure, so that they no longer must be absorbed by an individual girder.

In one embodiment, the spring strut receptacle has two diverging girders in this case, in particular an upper reinforcement part and a lower part. An additional load path for the acting forces is provided by the installation of an upper reinforcement part of the spring strut receptacle. The energy transmitted by the forces, in particular the kinetic energy, can be additionally dissipated thereby. The acting forces are not borne by one element alone, which has a positive effect on its wear and therefore its continuous operation behavior. Through the allocation of the acting forces, they may be better absorbed independently of their action angle, which has a positive effect in particular in the continuous operation behavior and/or in the event of a frontal impact. The risk that the forces will influence adjacent vehicle components is also minimized and they remain substantially undamaged with respect to their durability. In addition, plastic deformations may thus be suppressed better in the area of the force introduction by the spring strut.

These two parts of the spring strut receptacle may each be implemented like shells and may have a floor and an edge. This shape may also be referred to as dome-like, having a crest and edge sides, if the crest is on top. The upper reinforcement part is adapted to the lower part. The internal diameter of the upper reinforcement corresponds to the external diameter of the lower part of the spring strut receptacle, so that the lower part of the spring strut receptacle is arranged inside the upper reinforcement of the spring strut receptacle.

One advantage of this two-shell embodiment is that the spring strut receptacle can be significantly reduced in its sheet-metal thickness, since a material doubling with the upper reinforcement part occurs on the area in which the forces are introduced through the spring strut into the vehicle structure. Therefore, a significant weight reduction in relation to the prior art is possible, which additionally has a positive effect on future legal specifications for CO₂ emissions of new motor vehicles.

Furthermore, the upper reinforcement part can be connected to the lower part of the spring strut receptacle by a first connection between the floor of the upper reinforcement part and the floor of the lower part and by a connection between the edges of the two parts. Both the twisting stiffness and also the torsional stiffness of the system can be significantly increased by the structural attachment, since a material doubling occurs in the area of the force introduction to the spring strut receptacle and the two components are directly attached to one another on their edges, and thus form a unit and therefore further stabilize the entire system. The first and the second connections are formed in this case in a preferred embodiment from a plurality of spot welds, whereby a friction-locked connection results, which additionally contributes to the safety of the overall system.

In a further exemplary embodiment, this spring strut receptacle is incorporated into the vehicle front structure of a motor vehicle. The vehicle body structure can thus be implemented as particularly torsionally stiff in the area of the vehicle front wall. A more flexible design of the vehicle front structure in the area of headlights and radiator is also possible. Thus, for example, the lock crossbeam for receiving the lock of the engine hood or the headlight frame can be significantly reduced with respect to their structure and their sheet-metal thickness, which results in an additional weight reduction of the overall system.

The attachment between the upper reinforcement part of the spring strut receptacle and an inner wheel installation strut is preferably horizontal in relation to the spring strut in one embodiment, and the attachment of the lower part of the spring strut receptacle to the inner wheel installation strut is preferably arranged vertically in relation to the spring strut and therefore perpendicularly to the attachment of the upper reinforcement. Through the attachment in different planes, the twisting stiffness of the overall system is particularly high, where the dynamic spatial displacement of the fastening points of the spring strut in travel operation can be significantly reduced in all three spatial directions. Through this type of attachment, the twisting stiffness of the vehicle body is increased, i.e., the influence of torsional forces is reduced.

The connection of the upper reinforcement part to the inner wheel installation strut can be performed by means of common linkage technologies. Examples are spot welding or laser welding, riveting, or clenching. The lower part of the spring strut receptacle is preferably welded to the inner wheel installation strut. The spring strut receptacle can therefore be installed in the vehicle front structure by means of common connection technologies. No additional production costs or additional installation time therefore result.

Furthermore, the spot welds of the welded connection between the upper reinforcement and the inner wheel installation strut are arranged horizontally in relation to the spring strut, while in contrast the spot welds of the welded connection between the lower part and the wheel installation strut are arranged vertically in relation to the spring strut and therefore are perpendicular to one another. In this case, horizontally means a plane substantially parallel to the floor or the crest of the spring strut receptacle and vertically relates in this case to a plane perpendicular to the floor or the crest of the spring strut receptacle.

Through this arrangement, the spot welds are loaded both by shear and by tension, where the continuous running behavior of the motor vehicle is significantly improved. If the spot welds were only loaded with tension, they would tend to tear away and would therefore be considered critical with respect to the continuous running behavior of the motor vehicle. Lesser forces would also be introduced into the front area of the vehicle front structure by this attachment as compared to the prior art.

In a further embodiment, the upper reinforcement part and the lower part of the spring strut receptacle form a closed box profile together with a lateral wheel installation strut. This box profile is attached in a formfitting manner at the upper and the lower connections to the wheel installation strut and increases the stability of the entire system.

Furthermore, the wheel housing shell has a through hole for a support bearing of the spring strut and thus forms a local reinforcement therewith. Specific deformations, induced by the deformations of the support bearing, can therefore be avoided in the axial direction and in the radial direction.

Furthermore, such a vehicle front structure can be integrated in a motor vehicle. The vehicle front structure is implemented as torsionally stiff in the area of the vehicle front wall in such a way that a significant weight reduction of the entire vehicle is additionally possible, which in turn has a positive effect with respect to future specifications for the CO₂ emissions.

In summary, it is to be noted that significantly lesser forces are introduced into the front area of the vehicle body of a motor vehicle using the present invention. Through the attachment of the spring strut receptacle in different planes, the occurring energy can advantageously be relayed and the twisting stiffness of the passenger compartment and thus the safety of a motor vehicle for occupants and pedestrians can be significantly increased. Sheet-metal thicknesses can thus in turn be reduced and material can therefore be saved, which results in a significant weight reduction of the entire vehicle and therefore in significantly reduced CO₂ emissions.

Weight is therefore significantly reduced in relation to the total weight, the torsional stiffness and the twisting stiffness of the entire vehicle front structure are increased, the continuous running behavior of the vehicle is improved, and the energy in the event of a frontal impact is significantly better damped by the structural attachment.

### BRIEF DESCRIPTION OF THE DRAWINGS

The present invention will hereinafter be described in conjunction with the following drawing figures, wherein like numerals denote like elements, and:

FIG. 1 shows a schematic perspective view of a wheel housing shell and a spring strut receptacle according to an embodiment;

FIG. 2 shows a perspective view of an attachment of the upper reinforcement of the spring strut receptacle to the inner wheel installation strut according to an embodiment;

FIG. 2a shows a section along line IIa-IIa of FIG. 2, which illustrates the attachment of the upper reinforcement to the inner wheel installation strut;

FIG. 3 shows a schematic perspective view of an attachment of the spring strut receptacle to the sheet-metal structure of the wheel housing shell according to an embodiment;

FIG. 4 shows a schematic perspective view of a connection between the inner and the outer wheel installation struts according to an embodiment; and

FIG. 5 shows a cross-section through a detail of an attachment of the spring strut receptacle to the inner and outer wheel installation struts according to an embodiment.

### DETAILED DESCRIPTION

The following detailed description is merely exemplary in nature and is not intended to limit application and uses. Furthermore, there is no intention to be bound by any theory presented in the preceding background or summary or the following detailed description.

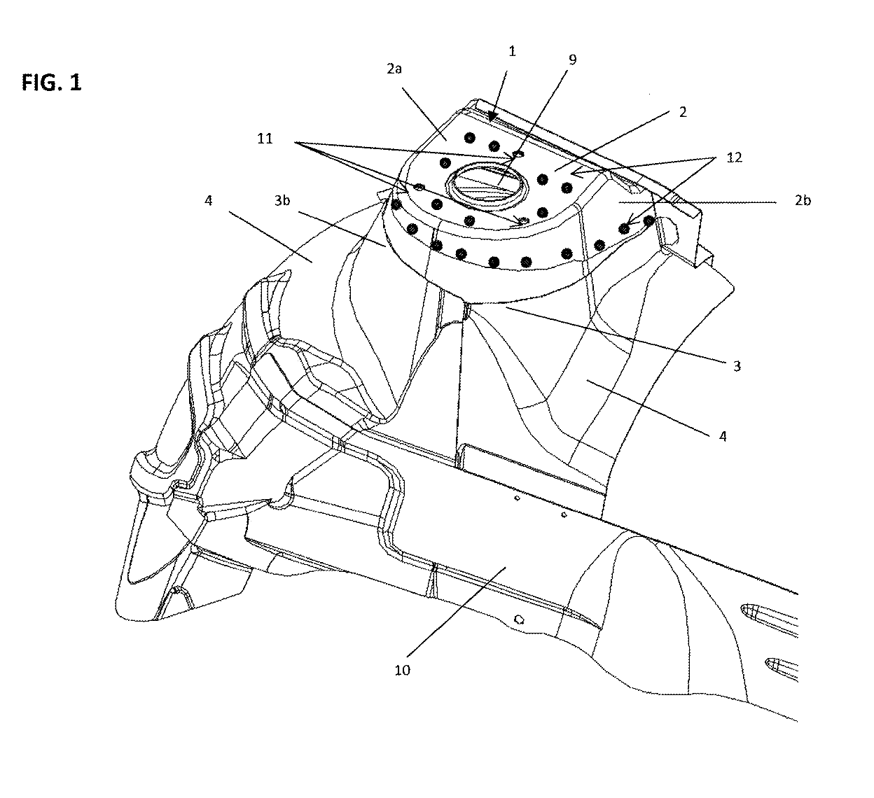

FIG. 1 shows a schematic perspective view of a wheel housing shell 4 and a spring strut receptacle 1 of a vehicle front structure of a motor vehicle according to an embodiment. The wheel housing shell 4 is connected at its upper end to the spring strut receptacle 1. The spring strut receptacle 1 is used to receive a spring strut (not shown), on the lower end of which a front wheel is fastened, which extends in a space in the form of a half-cupola, which is formed from wheel housing shell 4 and spring strut receptacle 1.

The spring strut receptacle 1 is implemented in two parts. It is composed of an upper reinforcement part 2 and a lower part of the spring strut receptacle 3, which are each implemented like shells and differ in their extension in the vertical and longitudinal directions. The upper reinforcement thus extends approximately transversely, while in contrast the lower part of the spring strut receptacle 3 has a stronger negative slope and therefore drops off more rapidly.

The two-subassembly parts 2, 3 of the spring strut receptacle 1 are connected to one another by a first welded connection 12 between the floor of the upper reinforcement 2a and the floor of the lower part of the spring strut receptacle 3a, and by a second welded connection 12 between their edges 2b, 3b. The internal diameter of the floor of the upper reinforcement 2a corresponds to the external diameter of the floor of the lower part of the spring strut receptacle 3b and the lower part of the spring strut receptacle 3 is arranged inside the upper reinforcement 2 of the spring strut receptacle 1.

To fix the upper end of the spring strut, the spring strut receptacle 1 has a recess on its surface, which is used as a through hole 9 for a support bearing, and through boreholes 11 for threaded bolts as fastening points for the spring strut. An additional reinforcement of the connection between spring strut and spring strut receptacle is produced by the welded connections 12 on the surface and the upper edge of the spring strut receptacle 1. In addition, a closing plate 10 of a front frame, which is connected at its upper end to the wheel housing shell 4, is shown as part of the vehicle front structure.

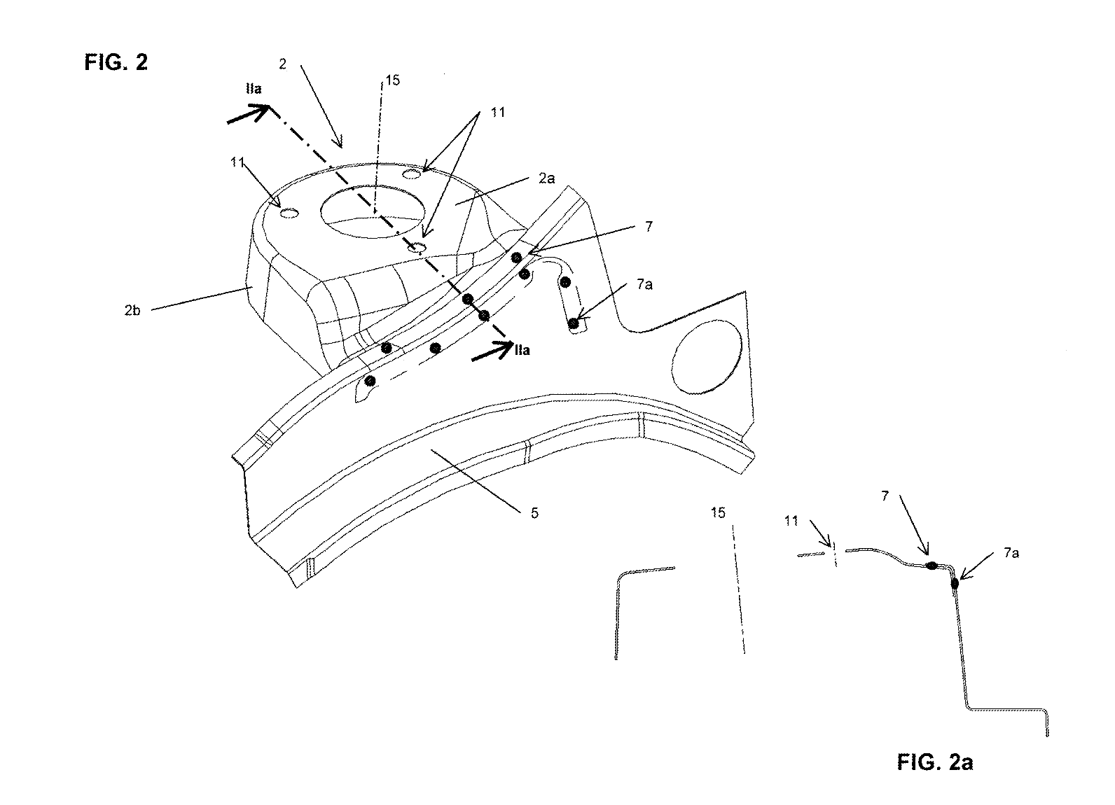

FIG. 2 shows the shell-like construction of the upper reinforcement 2 of the spring strut receptacle. It has a convex floor 2a, which is curved upward toward the spring strut, and which merges into an edge 2b of the upper reinforcement 2. The exemplary embodiment of FIG. 2 shows that the connection between the upper reinforcement 2 of the spring strut receptacle 1 and an inner wheel installation strut 5 is arranged horizontally and vertically in relation to the spring strut. The action line of the spring strut is illustrated by the dashed line 15. The connection is produced by means of common connection technologies. In the embodiment of the invention shown in FIG. 2, the upper reinforcement part 2 is welded to the inner wheel installation strut 5 and the spot welds 7, 7a of the connection are arranged horizontally 7 and vertically 7a in relation to the action line of the spring strut 15. The connection can also be produced by riveting, clenching, etc., however.

FIG. 2a once again clearly shows the structural attachment of the upper reinforcement 2 of the front spring strut receptacle to the inner wheel installation strut 5. The exemplary embodiment of FIG. 2 shows that the inner wheel installation strut 5, starting from the spring strut receptacle 1, first has a section adjoining thereon, which extends perpendicularly to the action line of the spring strut 15. This subsequently merges into a clearly longer section extending parallel to the action line of the spring strut 15, in the direction of the wheel housing shell 4, before the inner wheel installation strut 5 again has a section curved perpendicularly to the action line of the spring strut 15, extending away from the spring strut receptacle. The horizontal section of the inner wheel installation strut 5 adjoining the spring strut receptacle integrally adjoins the floor of the upper reinforcement 2a on the bottom and is connected thereto via a horizontal welded connection 7 there. The edge of the upper reinforcement 2b runs along the section extending parallel to the action line of the spring strut 15 and is connected at its end to the upper end of this section of the inner wheel installation strut 5 by means of an additional vertical welded connection 7a.

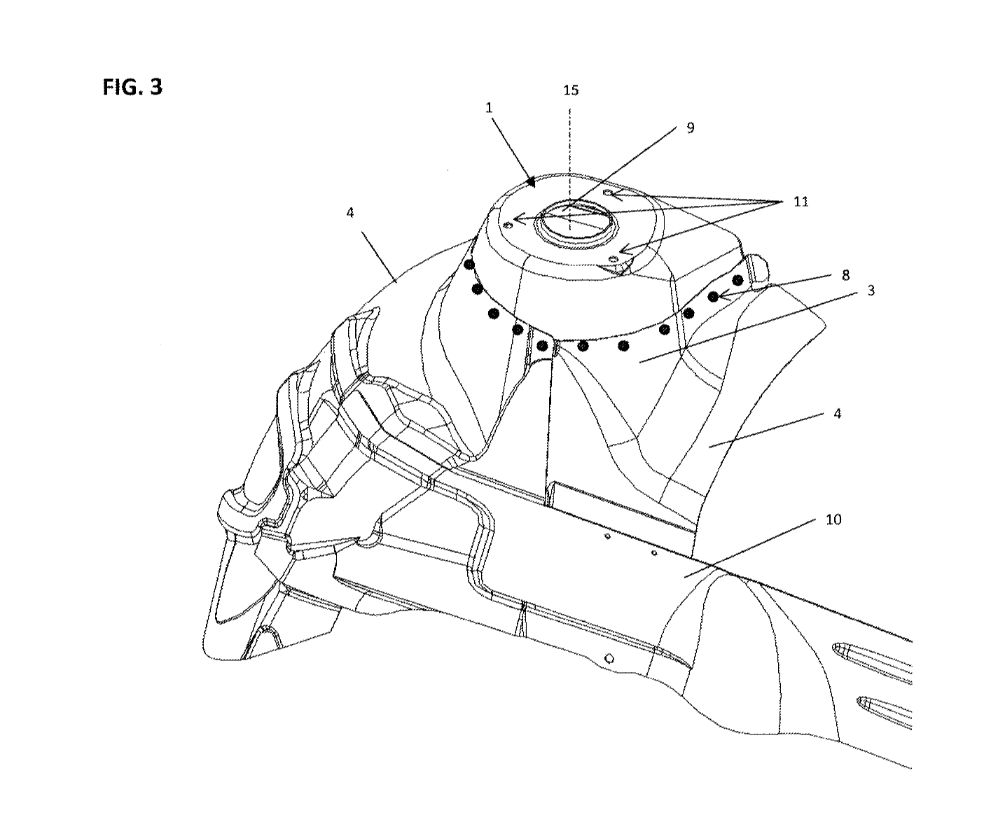

FIG. 3 shows the assembly of the wheel housing shell 4 and the spring strut receptacle 1. Components having identical functions as in FIG. 1 are identified by identical reference numerals and are not explained separately. In the exemplary embodiment of FIG. 3, the welded connections which connect the lower part of the spring strut receptacle 3 to the sheet-metal structure of the wheel housing shell 4 are arranged vertically in relation to the action line of the spring strut 15.

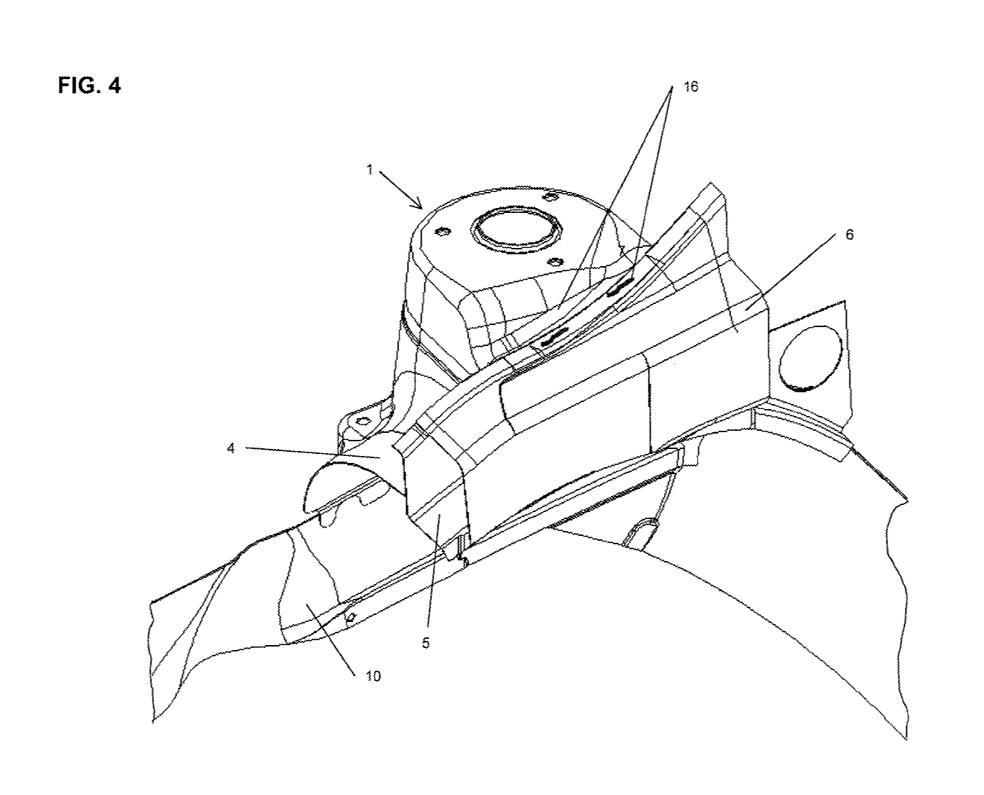

FIG. 4 schematically shows the connection of the inner wheel installation strut 5 to an outer wheel installation strut 6. Both wheel installation strut 5, 6 are connected to one another in the area of the spot welds 7 between the floor of the upper reinforcement and the inner wheel installation strut 5. A CO2 weld seam or a laser weld seam 16 is provided to connect the two wheel installation struts 5, 6. In the exemplary embodiment of FIG. 4, the outer wheel installation strut 6 initially extends perpendicularly to the action line of the spring struts 15, starting from the spring strut receptacle 1, before it merges into a section extending parallel to the action line of the spring strut 15, in the direction of the wheel housing shell 4, and is again connected at its end to the lower horizontal section of the inner wheel installation strut. Both wheel installation struts 5, 6 therefore form the surface of a hollow body between their connections.

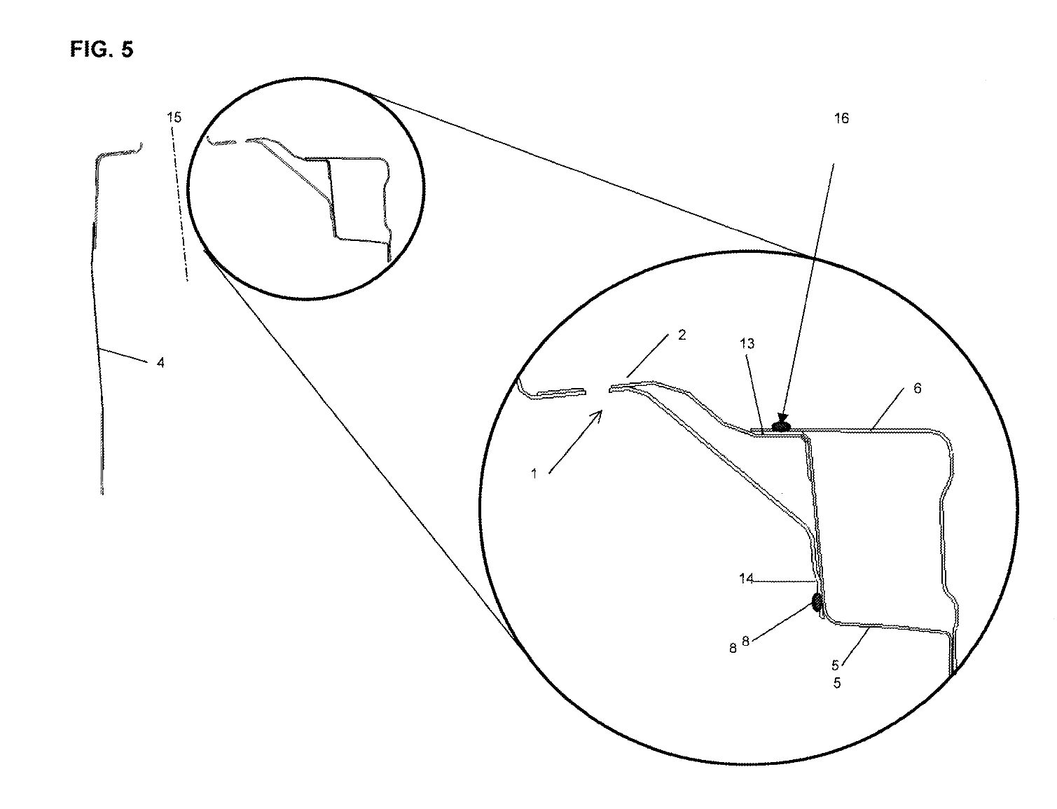

FIG. 5 shows a cross-section through a detail of an attachment of the spring strut receptacle 1 to the inner wheel installation strut 5. The inner wheel installation strut 5 is connected to an outer wheel installation strut 6. Both wheel installation struts 5, 6 are connected to one another at their front end, in the area of the upper end of the spring strut, and at their lower end. A mounting flange 13 is used to fasten the two wheel installation struts 5, 6 at their front end, the upper reinforcement 2 of the spring strut receptacle also being arranged on the flange. The horizontal welded connection 7 between the upper reinforcement 2 and the inner wheel installation strut is arranged horizontally in relation to the action line of the spring strut 15. A material doubling is thus produced in the area of the upper end of the spring strut on the surface into which the forces are introduced by the spring strut. Starting from the flange 13, the inner wheel installation strut first extends perpendicularly downward, parallel to the action line of the spring strut 15, up to a mounting flange 14 at the end of the lower part of the spring strut receptacle 3, which is used to connect the inner wheel installation strut 5 to the lower part of the spring strut receptacle 3. The welded connection 8 between the lower part of the spring strut receptacle 3 and the inner wheel installation strut 5 is arranged vertically in relation to the action line of the spring strut 15 at the lower end of the perpendicularly running part of the inner wheel installation strut 5. Subsequently, the inner wheel installation strut 5 extends horizontally toward the outer wheel installation strut 6, which, starting from the flange 13 of the front connection of the two wheel installation struts 5, 6, first extends horizontally and subsequently perpendicularly downward. The specified directions again relate to the action line of the spring strut 15. The upper reinforcement 2 and the lower part of the spring strut receptacle 3 are attached so that they form a closed box profile together with a lateral wheel installation strut.

While at least one exemplary embodiment has been presented in the foregoing summary and detailed description, it should be appreciated that a vast number of variations exist. It should also be appreciated that the exemplary embodiment or exemplary embodiments are only examples, and are not intended to limit the scope, applicability, or configuration in any way. Rather, the foregoing summary and detailed description will provide those skilled in the art with a convenient road map for implementing an exemplary embodiment, it being understood that various changes may be made in the function and arrangement of elements described in an exemplary embodiment without departing from the scope as set forth in the appended claims and their legal equivalents.

1. A spring strut receptacle for a motor vehicle, comprising:
a first part; and
a second part implemented with the first part to form the spring strut receptacle.

2. The spring strut receptacle according to claim 1,
wherein the first part is an upper reinforcement part, and
wherein the second part is a lower part.

3. The spring strut receptacle according to claim 2,
wherein the upper reinforcement part and the lower part are implemented as a shell,
wherein the upper reinforcement part and the lower part comprise a floor and an edge, and
wherein the upper reinforcement part is configured to the lower part.

4. The spring strut receptacle according to claim 3,
wherein the upper reinforcement part is connected to the lower part with a first connection between the floor of the upper reinforcement part and the floor of the lower part and by a second connection between the edge of the upper reinforcement part and the edge of the lower part.

5. The spring strut receptacle according to claim 4,
wherein the first connection and the second connection are formed from a plurality of spot welds.

6. (canceled)

7. The spring strut receptacle according to claim 2,
further comprising an attachment between the upper reinforcement part and an inner wheel installation strut that is arranged substantially horizontally.

8. The spring strut receptacle according to claim 2, further comprising an attachment between the lower part of the spring strut receptacle and an inner wheel installation strut arranged substantially vertically.

9. The spring strut receptacle according to claim 2, wherein the upper reinforcement part is welded to an inner wheel installation strut.

10. The spring strut receptacle according to claim 2, wherein the lower part is welded to an inner wheel installation strut.

11. The spring strut receptacle according to claim 2, further comprising a plurality of spot welds of a welded connection arranged substantially horizontally between the upper reinforcement part and a inner wheel installation strut.

12. The spring strut receptacle according to claim 11, wherein the plurality of spot welds of the welded connection between the lower part of the spring strut receptacle and the inner wheel installation strut are arranged substantially vertically.

13. The spring strut receptacle according to claim 1, wherein the upper reinforcement part and the lower part of the spring strut receptacle form a closed box profile with a lateral wheel installation strut.

14. The spring strut receptacle according to claim 3, wherein the shell has a through hole for a support bearing.

15. (canceled)
